(19) United States
(12) Patent Application Publication
(10) Pub. No.: US 2016/0029436 A1
(43) Pub. Date: Jan. 28, 2016

(54) AIR HEATER HAVING TWO-PIECE CERAMIC HOLDER AND CERAMIC HOLDER FOR AIR HEATER AND METHODS OF ASSEMBLY

(71) Applicants: Janez Urbas, Tolmin (SI); Miroslav Savli, Tolmin (SI); Uros Zagar, Tolmin (SI); Marko Kenda, Tolmin (SI); Elvis Gregorcic, Kobarid (SI)

(72) Inventors: Janez Urbas, Tolmin (SI); Miroslav Savli, Tolmin (SI); Uros Zagar, Tolmin (SI); Marko Kenda, Tolmin (SI); Elvis Gregorcic, Kobarid (SI)

(73) Assignee: Hidria AET, Tolmin (SI)

(21) Appl. No.: 14/805,587

(22) Filed: Jul. 22, 2015

Related U.S. Application Data
(60) Provisional application No. 62/028,678, filed on Jul. 24, 2014.

(51) Int. Cl. H05B 3/00; H05B 3/46; H05B 3/06

(52) U.S. Cl. CPC H05B 3/0014; H05B 3/06; H05B 3/46

(57) ABSTRACT

An air heater, method of assembling an air heater and a ceramic holder for an air heater are provided. The ceramic holder is formed from two parts that are operably mounted to the housing for securing a ceramic insulator to the housing.

### CROSS-REFERENCE TO RELATED PATENT APPLICATIONS

This patent application claims the benefit of U.S. Provisional Patent Application No. 62/028,678, filed Jul. 24, 2014, the entire teachings and disclosure of which are incorporated herein by reference thereto.

### FIELD OF THE INVENTION

This invention generally relates to air heaters and particularly air heaters for engine respiratory systems and more particularly to structures for mounting a heating ribbon relative to air flow into an engine.

### BACKGROUND OF THE INVENTION

Engine respiratory systems (often referred to as air intake systems) may incorporate an air heater to improve operation of the engine, particularly in cold climates. This may be particularly true for diesel engines.

One type of air heater utilizes electrical current through a heating ribbon to heat air passing through the ribbon. One particular type of electrical air heater is referred to as a grid heater. To mount the heating ribbon, the air heater may incorporate a ceramic insulator. It is important to properly mount the heating ribbon and the ceramic insulator to prevent excessive movement caused by vibration and possible damage of the components of the air heater.

In some installations, the holder of the ceramic insulator is often sandwiched between two different elements of the engine respiratory system. This sandwiching provides decent securement of the components of the air heater. However, if the electrical air heater is assembled directly into an intake manifold (i.e. drop in or insert) fixation of the holder of the ceramic insulator in a sandwich style, i.e between two different components of the respiratory system is not possible. As such, vibration resistance of an electrical air heater assembled directly into an intake manifold is poorer.

For example, some manufactures use a system described in U.S. Pat. No. 7,406,957. However, use of this type of design results in a housing that is weakened and this can lead to cracking in the housing and damage to the engine.

The invention provides improvements over the current state of the art for mounting the heating ribbon and use of ceramic insulators in air heaters.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top perspective illustration of an air heater according to an embodiment of the invention;

FIG. 2 is a bottom illustration of a portion of the air heater of FIG. 1;

FIG. 3 is a top illustration of the portion of the air heater of FIG. 2;

FIG. 4 is a cross-sectional illustration of a portion of the air heater of FIG. 1 in an assembled state; and

FIG. 5 is a cross-sectional illustration of the air heater similar to FIG. 4 illustrating a step of forming a bent tab.

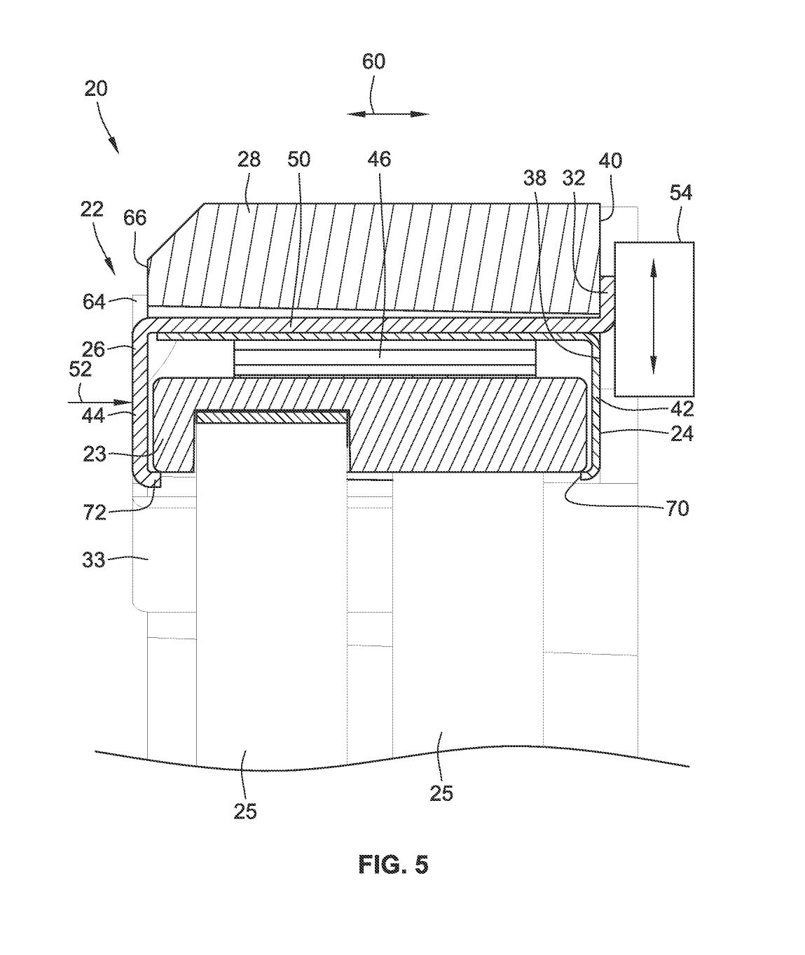

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

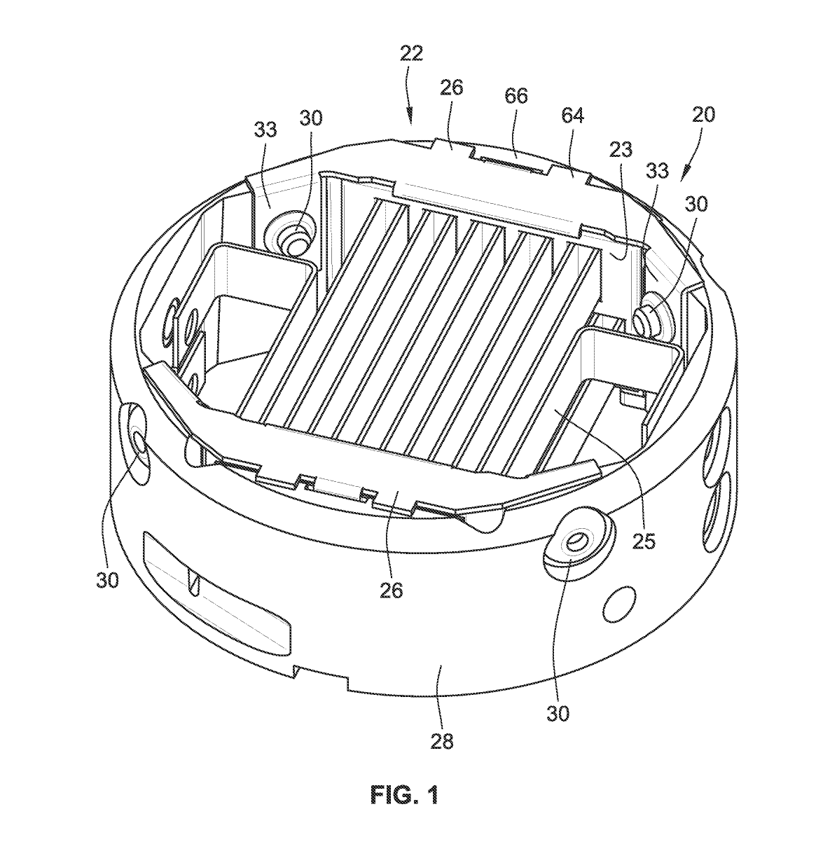

FIG. 1 is a top view of an embodiment of an air heater 20 according to the invention. The air heater includes a two piece ceramic holder 22 for holding a ceramic insulator 23 in which the one or more heating ribbons 25 are mounted.

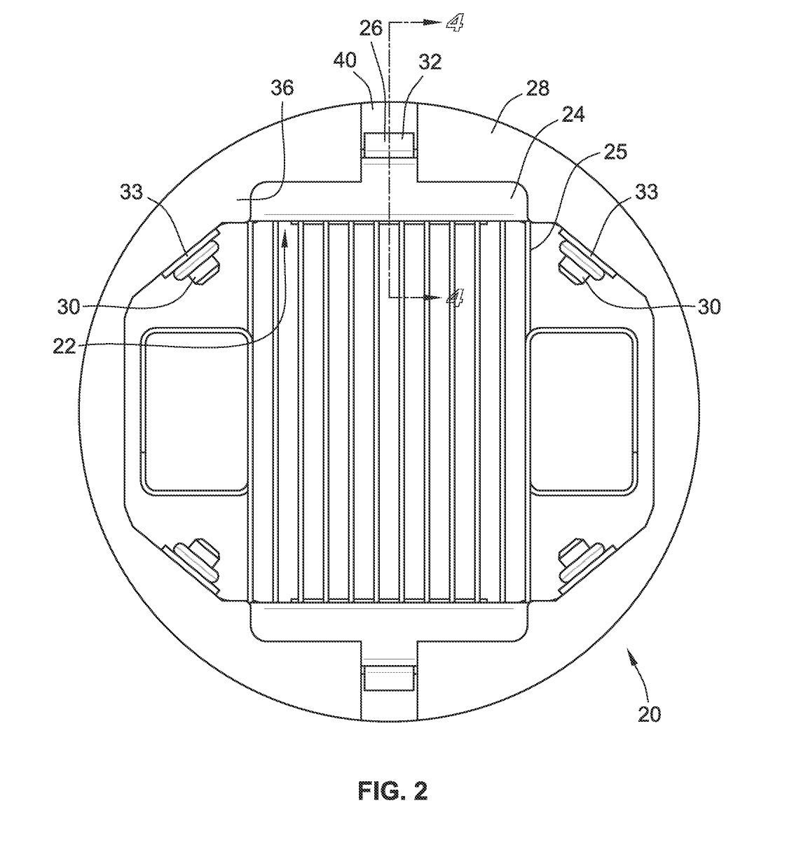

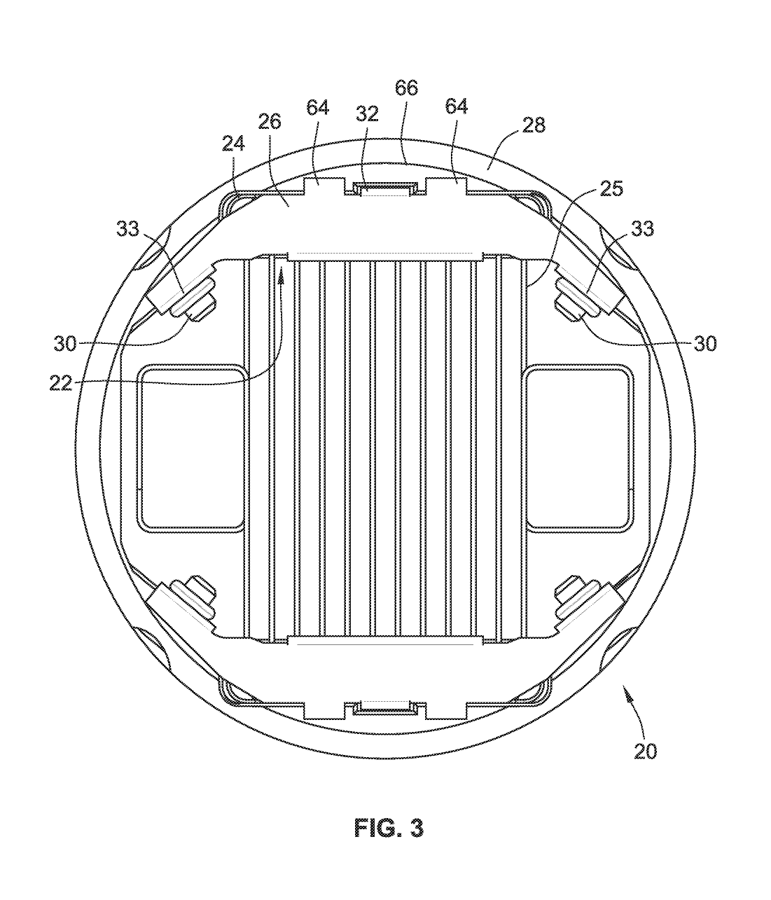

FIG. 2 is a bottom illustration of the air heater of FIG. 1. FIG. 3 is a partial top illustration of the air heater 20 of FIG. 1. FIG. 2 illustrates a first part 24 of the ceramic holder 22 and FIG. 3 illustrates a second part 26.

The first part 24 of the ceramic holder 22 is supported by an aluminum housing 28. The second part 26 is attached to the aluminum housing 28 by rivets 30 that extend through wing or flange portions 33 of the second part 26 as well as a bent tab 32.

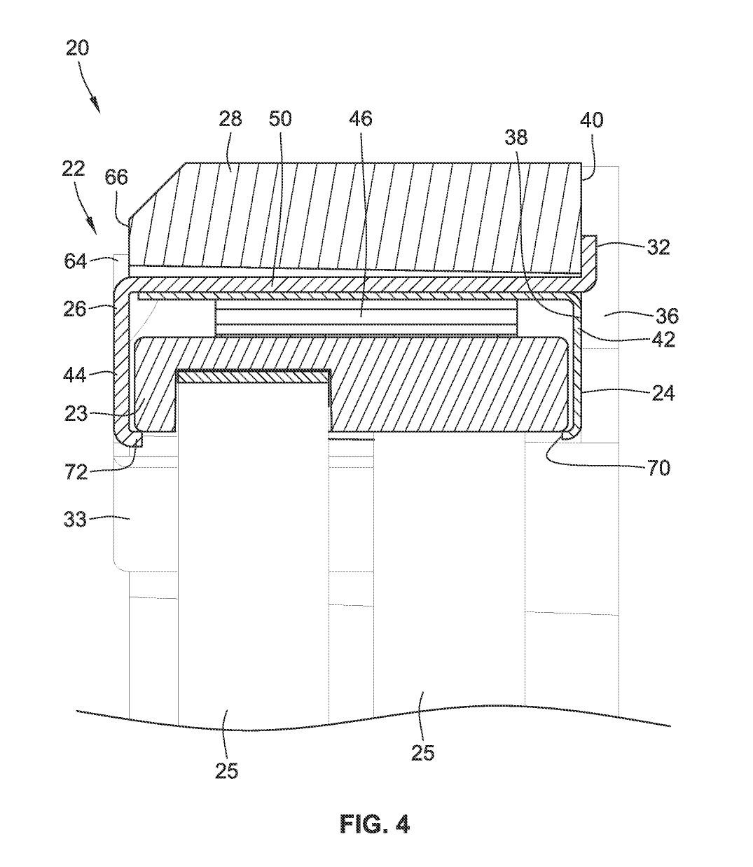

FIG. 4 is a cross-sectional illustration of a portion of the air heater of FIG. 1 illustrating the mounting of the ceramic holder 22 in more detail. In FIG. 4, the first part 24 of the ceramic holder 22 is supported by the housing 28. More particularly, the first part 24 rests on a surface 38 of a shelf portion 36 of the housing 28.

The bent tab 32 of the second portion 26 engages a further surface 40 of the housing 28 which hooks the bent tab 32 and the second part 26 to the housing 28. Surfaces 38 and 40 face in opposite directions.

The ceramic insulator 23 is sandwiched between the first and second parts 24, 26 and more particularly between flange portions 42, 44 thereof. A compensation spring 46 is also positioned between flange portions 42, 44 and biases the ceramic insulator 23 towards the heating ribbon 25.

During assembly, the first part 24 of the ceramic holder 22 is supported by the housing 28 and against shelf portion 36. The ceramic insulator, spring 46 and heating ribbon 25 are inserted into the first part 24.

Thereafter, the second part 26 is inserted over these components. Prior to insertion of the second part 26, the bent tab 32 is not formed. The positioning and configuration of the first part 24 and housing 28 defines a clearance or passage in which the second part 26 may be inserted between the first part 24 and housing 28. Prior to formation of the bent tab 32, the portion that forms the bent tab 32 is more closely planar with rear wall 50 of the second part 26.

After the second part 26 is pushed into place, a side force, illustrated by arrow 52 is applied to the second part 26 of the ceramic holder 22 to generate a preload between the housing 28 and the second part 26 of the ceramic holder 22. Rivets 30 are installed to generally secure the second part 26 in place and to the housing 28.

After the rivets 30 are installed, and while the preload 52 is active on the second part 26, a tool 54 forms the bent tab 32 by bending the appropriate portion of the second part 26 onto and against surface 40 to secure the second part 26 to housing 28.

After the side force 52 is removed, the preload that was imparted to the second part prevents any gaps or clearance between the housing 28 and the second part 26 or movement in a direction illustrated by arrow 60. The second part 26 may include locating tabs 64 that act on an opposite side of the housing as the bent tab 32 and more particularly onto a surface 66 that faces in an opposite direction as surface 40 that is engaged by the bent tab 32.

The first and second parts 24, 26 also include bent retaining flanges 70, 72 that hook around the front of the ceramic insulator 23.

While the housing 28 is illustrated as circular, other embodiments could be other shapes.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An air heater comprising:
a housing defining a through passage through which air can pass;
a ceramic insulator;
a ceramic holder mounting the ceramic insulator to the housing, the ceramic holder including a first part and a second part, the ceramic insulator being mounted between the first and second parts;
a heater ribbon mounted to the ceramic insulator.

2. The air heater of claim 1, wherein the first part is operably secured to the housing by the second part.

3. The air heater of claim 2, wherein the second part includes a bent tab engaging a portion of the housing to preload the second part against the housing.

4. The air heater of claim 2, wherein the second part includes a mechanical fastener for securing the second part to the housing.

5. The air heater of claim 4, wherein the mechanical fastener is a rivet.

6. The air heater of claim 1, wherein the housing defines a shelf against which the first part is axially biased.

7. The air heater of claim 1, wherein the second part acts as a retainer for securing the first part and ceramic insulator mounted to the housing.

8. The air heater of claim 1, wherein the housing and the first part define a clearance area through which a portion of the second part extends, a bent clip being attached to the portion of the second part extending through the clearance, the bent clip engaging the housing to preload the second part against the housing.

9. A method of assembling an air heater comprising:
locating a first part of a ceramic holder against a shelf of a housing;
inserting a ceramic insulator into the first part;
attaching a second part of a ceramic holder to the housing; and
securing the second part to the housing to secure the first part, second part and ceramic insulator to the housing.

10. The method of claim 9, wherein the step of securing the second part to the housing includes bending a portion of the second part into engagement with the housing.

11. The method of claim 10, wherein the step of bending a portion of the second part includes forming a bent tab that provides preloading of the second part against the housing.

12. The method of claim 9, wherein the step of securing the second part to the housing includes using a mechanical fastener.

13. The method of claim 12, further comprising bending a portion of the second part to form a bent tab that engages the housing that provides preloading of the second part against the housing.

14. A ceramic holder for holding a ceramic insulator for an air heater to a housing through which air passes and is heated, the ceramic holder comprising:
a first part that is configured to be pressed against a portion of the housing; and
a second part that is configured to be attached to the housing to secure the first and second parts to the housing.
